(19) United States
(12) Patent Application Publication
(10) Pub. No.: US 2026/0276562 A1
(43) Pub. Date: Sep. 17, 2026

(54) CELL ASSEMBLY FOR ELECTRODE STRUCTURAL OBSERVATION

(71) Applicant: HONDA MOTOR CO., LTD., Tokyo (JP)

(72) Inventors: Keiko SUZUKI, Saitama (JP); Atsushi SAKURAI, Saitama (JP)

(21) Appl. No.: 19/565,510

(22) Filed: Mar. 12, 2026

(30) Foreign Application Priority Data
Mar. 17, 2025 (JP) 2025-042191

(51) Int. Cl. G01N 23/046; G01N 23/083

(52) U.S. Cl. CPC G01N 23/046; G01N 23/083

(57) ABSTRACT

Provided is a cell assembly for electrode structural observation that is less likely to block X-ray irradiation of a cell which is an observation target. A cell assembly 1 for structural observation for observing an internal structure of a cell with an X-ray CT includes a pair of metal leaf springs 11, 12 that allow the cell, which is an observation target, to be sandwiched and restrained from both surfaces of the cell, and a sample holding part (resin plate material 10) that is arranged between the metal leaf springs 11, 12. Fixing positions of the pair of metal leaf springs 11, 12 are closer to an electrode of the cell in a biasing direction than contact points between the metal leaf springs and the sample holding part, and the sample holding part includes a thin X-ray irradiated portion 40.

### CROSS REFERENCE TO RELATED APPLICATIONS

This application is based on and claims priority under 35 U.S.C. §119 from Japanese Patent Application No. 2025-042191, filed on 17 Mar. 2025, the content of which is incorporated herein by reference.

### BACKGROUND OF THE INVENTION

### Field of the Invention

The present invention relates to a cell assembly for electrode structural observation.

### Related Art

A cell which is a constituent element of a secondary battery module undergoes expansion and contraction during charge and discharge. Therefore, the electrodes are often restrained in a thickness direction in use. Techniques for observing the structure of the electrodes in a state simulating such a state of use have been proposed. For example, by one of the techniques, a cross section of the electrodes is observed using a scanning electron microscope (SEM) or a confocal optical system with the electrodes restrained in the thickness direction by a restraining member. If an expansion and contraction amount of the electrodes is large, it is difficult for these techniques to completely reduce the expansion of the electrodes in a protruding direction from a cross section processed for the observation. Therefore, there is concern that the observation results may be different from the behavior of the structure in actual use. Although the above-described concern is resolved if the cross section is observed by an X-ray CT which does not require processing of the cross section for observation, the image quality of X-ray CT images deteriorates due to X-ray absorption by the restraining member that restrains the electrodes in the thickness direction. The deterioration of image quality becomes an obstacle to making detailed observation.

As a cell assembly for electrode structural observation that allows the X-ray CT observation of a cell of a secondary battery restrained by a restraining member in the thickness direction, an assembly using a restraining member in which an X-ray irradiated portion having a relatively thin thickness is provided in the vicinity of a center portion has been proposed (for example, see Patent Document 1).

Patent Document 1: Japanese Unexamined Patent Application, Publication No. 2024-112470

### SUMMARY OF THE INVENTION

According to the cell assembly for electrode structural observation of Patent Document 1, although a region in which a displacement is detected in the restraining member has a thin thickness, the absorption of X-rays by the restraining member is not zero. Therefore, the image quality of X-ray CT images deteriorates due to X-ray absorption by the restraining member, which may cause an obstacle to making detailed observation. In recent years, increasing efforts have been made to achieve a low-carbon or decarbonized society, and research and development of devices for developing or testing electronic elements for vehicles is taking place in view of reduction of CO₂ emissions and improvement in energy efficiency.

In view of the above-described circumstances, the present invention has been made to provide a cell assembly for electrode structural observation that is less likely to block X-ray irradiation of a cell which is an observation target. The present invention further has an object to provide a cell assembly for electrode structural observation that can acquire a high precision X-ray CT image even if the cell expands and contracts. Furthermore, the present invention reduces the blocking of the X-ray irradiation of the cell, contributing to improvement in energy efficiency.

(1) A cell assembly for structural observation for observing an internal structure of a cell with an X-ray CT, the assembly including a pair of metal leaf springs that allow the cell, which is an observation target, to be sandwiched and restrained from both surfaces of the cell, and a sample holding part that is arranged between the metal leaf springs. Fixing positions of the pair of metal leaf springs are closer to a terminal side of an electrode of the cell in a biasing direction than contact points between the metal leaf springs and the sample holding part, and the sample holding part includes a thin X-ray irradiated portion.

According to such a cell assembly for structural observation, there can be provided a cell assembly for electrode structural observation that is less likely to block X-ray irradiation of a cell which is an observation target. There can be provided a cell assembly for electrode structural observation that can acquire a high precision X-ray CT image even if the cell expands and contracts.

(2) In the above-described cell assembly for structural observation, the sample holding part includes thick side wall portions facing each other via the X-ray irradiated portion, and tips of the metal leaf springs respectively contact the side wall portions.

According to such a cell assembly for structural observation, it becomes easy to arrange the fixing positions of the metal leaf springs closer to an electrode in a biasing direction than contact points between the metal leaf springs and the sample holding part while reducing the absorption of the X-rays by the sample holding part.

(3) In the above-described cell assembly for structural observation, the sample holding part has a concave shape in a cross-sectional view in a thickness direction, a bottom of the concave shape is the X-ray irradiated portion, and portions corresponding to side walls of the concave shape are the side wall portions.

According to such a cell assembly for structural observation, the sample holding part is formed in a concave shape so that the contact points between the metal leaf springs and the sample holding part are located above the fixing positions of the metal leaf springs, and a recessed portion of the concave shape is used as the X-ray irradiated portion, which makes it possible to reduce the absorption of the X-rays by the sample holding part.

(4) In the above-described cell assembly for structural observation, the tips of the metal leaf springs each have an arc shape, and a radius of the arc shape is set so that a movement of the contact points with the sample holding part by rotation of the metal leaf springs about the fixing positions of the metal leaf springs and a movement of the contact points with the sample holding part by rolling of the arc shape are performed in the same direction and by the same distance

According to such a cell assembly for structural observation, a positional deviation in the contact points between the metal leaf springs and the sample holding part can be restrained even if the cell expands and contracts.

According to the present invention, there can be provided a cell assembly for electrode structural observation that is less likely to block X-ray irradiation of a cell which is an observation target.

### BRIEF DESCRIPTION OF THE DRAWINGS

FIG. 1 is a perspective view of a cell assembly for structural observation of the present disclosure;

FIG. 2 is a cross-sectional view of the cell assembly for structural observation taken along line A-A in FIG. 1;

FIG. 3A is a diagram illustrating movement of a contact point of a metal leaf spring in the present disclosure;

FIG. 3B is a diagram illustrating movement of a contact point of a metal leaf spring in a comparative example;

FIG. 4 is a diagram for describing a method of calculating a movement amount of the contact point of the metal leaf spring.

### DETAILED DESCRIPTION OF THE INVENTION

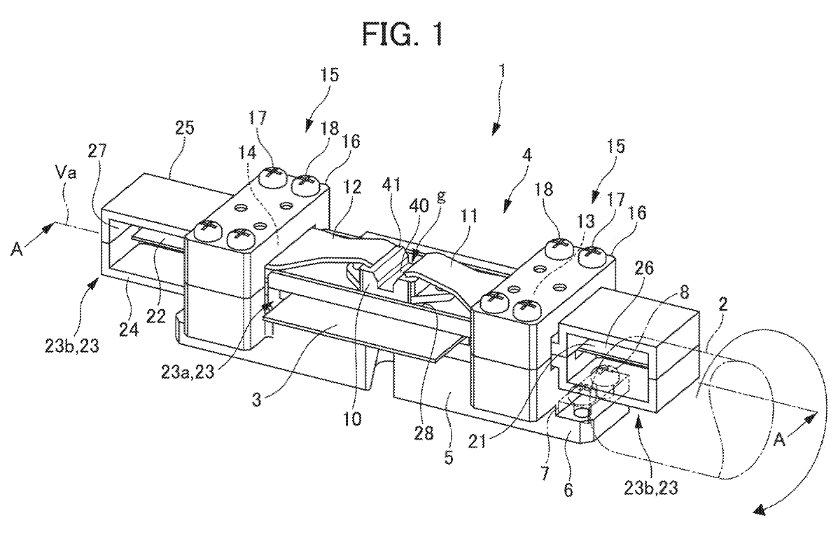

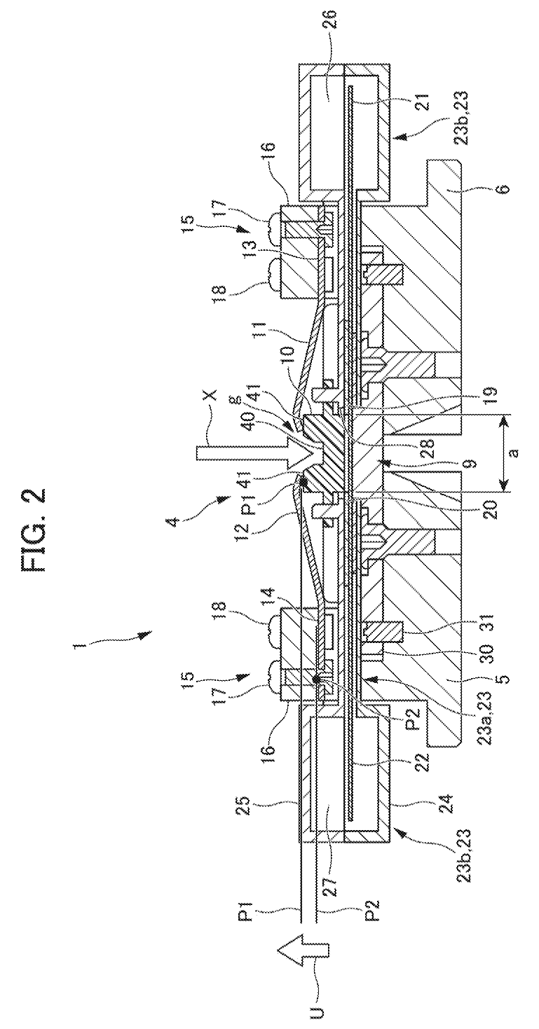

FIG. 1 is a perspective view of a cell assembly 1 for structural observation of the present disclosure. FIG. 2 is a cross-sectional view of the cell assembly 1 for structural observation taken along line A-A. FIG. 1 illustrates the cell assembly 1 for structural observation attached to a rotation support member 2 described later, and a rotation axis (virtual rotation axis Va) of the cell assembly 1 for structural observation and the rotation support member 2 is shown to be inclined with respect to a vertical direction, but the direction of the rotation axis Va is suitably determined depending on the form or working situation of an X-ray CT (not illustrated) to be applied.

The cell assembly 1 for structural observation is an assembly for observing the internal structure of a cell which is a constituent element of a secondary battery module with the X-ray CT (not illustrated). The cell assembly 1 for structural observation includes a leaf spring 4 that allows a flat cell 3, which is an observation target, to be sandwiched and restrained from both surfaces of the cell 3 in a thickness direction. The leaf spring 4 includes a base member 5 which is a plate-shaped member having a longitudinal direction parallel to the rotation axis Va. The base member 5 is fastened, at a base portion 6 on one end in the longitudinal direction, to a mounting portion 7 which is rectangular parallelepiped-shaped, for example, and protrudes from a tip surface of the rotation support member 2 with screws 8. The rotation support member 2 is rotated by a rotary drive mechanism (not illustrated), turning the cell assembly 1 for structural observation.

A resin plate material 10 is provided on one of main surfaces of the base member 5. The resin plate material 10 serves as a sample holding part that is arranged to cover a region a of an electrode opposing part 9 related to the observation of the cell 3 on one surface of both surfaces of the cell 3. The leaf spring 4 includes two metal leaf springs 11 and 12 that form a pair of metal leaf springs and press and bias a surface of the resin plate material 10 on a side not in contact with the cell 3. The two metal leaf springs 11 and 12 extend to face each other in a direction parallel to a main surface of the resin plate material 10 toward a center portion of the resin plate material 10 with a predetermined gap g formed between extended ends of the metal leaf springs 11 and 12. The gap g is formed to align with a position irradiated with X-rays by the X-ray CT (a position indicated by an open downward arrow in FIG. 2). That is, the gap g is formed in the region a of the electrode opposing part 9. In other words, the extended ends of the two metal leaf springs 11 and 12 are located in the region a of the electrode opposing part 9.

The two metal leaf springs 11 and 12 are supported by respective support members 15, at their base portions opposite to the extended ends facing the gap g, that is, a base part 13 of the metal leaf spring 11 and a base part 14 of the metal leaf spring 12. Each support member 15 includes a leaf spring mounting plate 16 arranged on a main surface of the corresponding one of the two metal leaf springs 11 and 12, the main surface being opposite to the base member 5, leaf spring fastening screws 17 that fasten the corresponding one of the two metal leaf springs 11 and 12 to the leaf spring mounting plate 16, and mounting plate fastening screw 18 that fasten the leaf spring mounting plate 16 to the base member 5. In this example, the screws 8, the leaf spring fastening screws 17, and the mounting plate fastening screws 18 are male screws, and screwed into associated female-threaded holes. As illustrated in FIG. 1, two each of the leaf spring fastening screw 17 and the mounting plate fastening screws 18 are used.

When the cell 3 is pressed and restrained by the two metal leaf springs 11 and 12 via the resin plate material 10 at a regular position for the observation with the X-ray CT, a negative electrode terminal 19 of the cell 3 is located at substantially the same position as the extended end of the metal leaf spring 11 when viewed from the front. A positive electrode terminal 20 of the cell 3 is located at substantially the same position as the extended end of the metal leaf spring 12 when viewed from the front. A negative electrode bus bar 21 extends from the negative electrode terminal 19 to be close to the base part 13 of the metal leaf spring 11 when viewed from the front. A positive electrode bus bar 22 extends from the positive electrode terminal 20 to be close to the base part 14 of the metal leaf spring 12 when viewed from the front. The negative electrode bus bar 21 and the positive electrode bus bar 22 are arranged as described above. Thus, the region a of the electrode opposing part 9 is located between the negative electrode bus bar 21 and the positive electrode bus bar 22.

A container 23 made of an insulating material contains the cell 3, the negative electrode terminal 19, the negative electrode bus bar 21, the positive electrode terminal 20, and the positive electrode bus bar 22. The container 23 has a first flat container portion 23a that is in close contact with the base member 5 via a base member fixing plate 30, and a second container portion 23b that is not in close contact with the base member 5 and in which an opening described later is formed. The base member fixing plate 30 is fixed to the base member 5 by base member fixing plate fastening screws 31. The container 23 includes a first container half 24 and a second container half 25. The cell 3, the negative electrode terminal 19, the negative electrode bus bar 21, the positive electrode terminal 20, and the positive electrode bus bar 22 are contained in a container space formed between the first container half 24 and the second container half 25 by being sandwiched between the first container half 24 and the second container half 25. A negative electrode opening 26 is formed in a side surface of an end portion of the container 23 near the base part 13 of the metal leaf spring 11. The negative electrode opening 26 is a window that allows the negative electrode bus bar 21 to be energized from outside. A positive electrode opening 27 is formed in a side surface of an end portion of the container 23 near the base part 14 of the metal leaf spring 12. The positive electrode opening 27 is a window that allows the positive electrode bus bar 22 to be energized from outside.

A window 28 penetrating the second container half 25 in the thickness direction is formed at a position in the second container half 25 corresponding to the region a of the electrode opposing part 9 so that the surface of the resin plate material 10 on a side not in contact with the cell 3 is exposed through the window 28, the surface being the other surface opposite to one surface of the resin plate material 10 on the side in contact with the cell 3. Thus, a biasing force of the two metal leaf springs 11 and 12 pressing the other surface of the resin plate material 10, that is the surface on a side not in contact with the cell 3 effectively acts on the cell 3 via the resin plate material 10. That is, the extended ends of the two metal leaf springs 11 and 12 facing each other pressurize the cell 3 via the resin plate material 10.

Accordingly, the region a of the electrode opposing part 9 in the cell 3 is pressurized directly in a region of the resin plate material 10 spreading in a plane direction. This allows the two metal leaf springs 11 and 12 to effectively pressurize the whole region a of the electrode opposing part 9, while keeping the moment length from the respective base parts 13 and 14 to the extended ends, which are ends on which the biasing force acts, relatively short. This can reduce strength required for the two metal leaf springs 11 and 12 and the support members 15 including the leaf spring fastening screws 17, the leaf spring mounting plates 16, and the mounting plate fastening screws 18.

As the two metal leaf springs 11 and 12, different pairs of metal leaf springs having the same planar shape projected on the main surface of the base member 5 and different spring constants are prepared. The different pairs of metal leaf springs 11 and 12 are typically made of the same metal and have different thicknesses. The different pairs of metal leaf springs 11 and 12 have the same planar shape projected on the main surface of the base member 5, and thus, are easily detachably attached to the respective leaf spring mounting plates 16 with the leaf spring fastening screws 17.

This allows the X-ray CT observation of the properties of the cell 3 under a different pressing force applied to the cell 3 via the resin plate material 10 by replacing the two metal leaf springs 11 and 12 with a different pair of metal leaf springs having a different spring constant. The two metal leaf springs 11 and 12 can be replaced by detachably attaching the metal leaf springs 11 and 12 to the leaf spring mounting plates 16 with the leaf spring fastening screws 17 as described above, or by detachably attaching blocks each having the metal leaf spring 11 or 12 fixed to the leaf spring mounting plate 16 with the leaf spring fastening screws 17 to the base member 5 with the mounting plate fastening screws 18.

As the different pairs of metal leaf springs 11 and 12 having different spring constants, for example, the following two types are prepared. The pair of metal leaf springs of the first type have a biasing force ranging from 0.1 MPa to 1.0 MPa, and the pair of metal leaf springs of the second type have a biasing force ranging from 2.0 MPa to 4.0 MPa.

While the above-described cell assembly 1 for structural observation attached to the rotation support member 2 rotates about the virtual rotation axis Va, the X-ray CT (not illustrated) irradiates the cell 3 with the X-rays as indicated by an open arrow in FIG. 2, obtaining a CT image as the observation result of the cell 3. The current passing through the negative electrode bus bar 21 and the positive electrode bus bar 22 is controlled using the negative electrode opening 26 and the positive electrode opening 27 at appropriate timing, so that the observation is carried out by changing the SOC of the cell 3.

The shape of the resin plate material 10 serving as the sample holding part will be described. In the following description, a direction of an arrow U illustrated in FIG. 2 is defined as the upward direction (thickness direction). The resin plate material 10 has a concave shape in a cross section parallel to the thickness direction. A bottom of the concave shape in the resin plate material 10 is referred to as an X-ray irradiated portion 40. The X-ray irradiated portion 40 corresponds to a recessed portion in the concave shape. The X-ray irradiated portion 40 is a thin portion whose thickness is thinner in the resin plate material 10. The X-ray irradiated portion 40 is located at an X-ray irradiation position indicated by an arrow X. The thin X-ray irradiated portion 40 is formed in the resin plate material 10, which makes it possible to reduce the absorption of the X-rays by the resin material forming the resin plate material 10. In other words, a recess is formed in the resin plate material 10 whose thickness is increased, so that the resin plate material 10 has a concave shape. Then, the X-rays are allowed to pass through the concave-shaped thin portion. This makes it possible to reduce the absorption of the X-rays by the resin material. As a result, it is easy to acquire a high precision X-ray CT image. The resin plate material 10 can be formed of, for example, a carbon fiber reinforced plastic (CFRP). This makes it possible to have a strength capable of withstanding a high load and obtain high X-ray transmittance.

A portion corresponding to a side wall of the concave shape in the resin plate material 10 is referred to as a side wall portion 41. A pair of side wall portions 41 are located on both sides of the X-ray irradiated portion 40 in the cross section parallel to the thickness direction. The side wall portions 41 each are a thick portion whose thickness is thicker in the resin plate material 10. The side wall portions 41 contact respective tips of the metal leaf springs 11 and 12. This makes it possible to make the fixing positions of the metal leaf springs 11 and 12 lower than positions of the metal leaf springs 11 and 12 contacting the resin plate material 10. In FIG. 2, the position of the metal leaf spring 11, 12 contacting the resin plate material 10 is shown as a spring contact point P1. A position at which the metal leaf spring 11, 12 is fixed by the leaf spring mounting plate 16 in the base part 13, 14 is shown as a leaf spring fixing position P2. As illustrated in FIG. 2, the leaf spring fixing position P2 can be set at a position lower than the spring contact point P1.

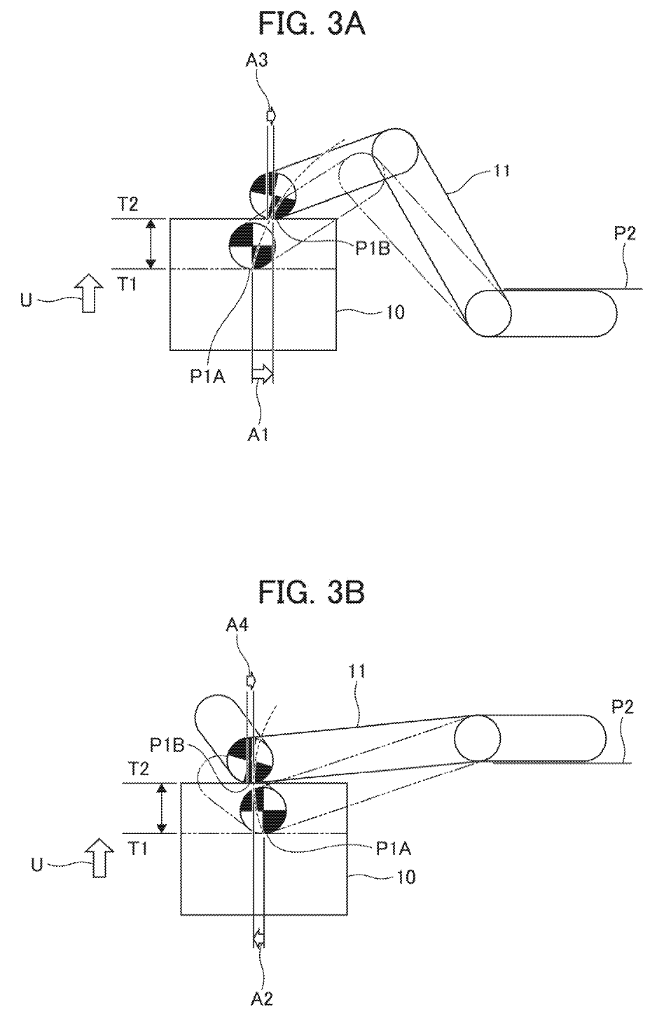

FIG. 3A is a diagram schematically illustrating how the spring contact point P1 of the metal leaf spring 11 in the present disclosure moves. FIG. 3B is a diagram schematically illustrating how a spring contact point P1 of a metal leaf spring 11 in a comparative example moves. The following description will be made by taking the metal leaf spring 11 as an example, but the matters described below also apply to the metal leaf spring 12. As illustrated in FIGS. 3A and 3B, the resin plate material 10 moves upward and downward in conjunction with the fluctuation of the electrode thickness due to the expansion and contraction behavior of the cell. A height of a lower position of the resin plate material 10 is indicated by T1, and a height of an upper position of the resin plate material 10 is indicated by T2. The height of the resin plate material 10 moves upward and downward between the height T1 and the height T2. The spring contact point P1 changes with the change in height of the resin plate material 10. The spring contact point P1 when the height of the resin plate material 10 is T1 is shown as a first spring contact point P1A, and the spring contact point P1 when the height of the resin plate material 10 is T2 is shown as a second spring contact point P1B.

As illustrated in FIG. 3A, in the metal leaf spring 11 in the present disclosure, the leaf spring fixing position P2 is located at a position lower than any of the first spring contact point P1A and the second spring contact point P1B. In contrast, in the metal leaf spring 11 in the comparative example, as illustrated in FIG. 3B, the leaf spring fixing position P2 is located at a position higher than any of the first spring contact point P1A and the second spring contact point P1B. Due to the difference in the leaf spring fixing position P2, the moving direction of the spring contact point P1 when the height of the resin plate material 10 is changed is different between the present disclosure and the comparative example. In the following description, a direction perpendicular to the upward direction U is defined as a lateral direction. As illustrated in FIG. 3A, in the metal leaf spring 11 of the present disclosure in which the leaf spring fixing position P2 is located lower than the spring contact point P1, when the height of the resin plate material 10 changes from T1 to T2, the spring contact point P1 moves in a direction approaching the leaf spring fixing position P2 in the lateral direction as indicated by an arrow A1. In contrast, in the metal leaf spring 11 of the comparative example in which the leaf spring fixing position P2 is located higher than the spring contact point P1, as illustrated in FIG. 3B, when the height of the resin plate material 10 changes from T1 to T2, the spring contact point P1 moves in a direction away from the leaf spring fixing position P2 in the lateral direction as indicated by an arrow A2. Thus, the moving direction of the spring contact point P1 when the metal leaf spring 11, 12 rotates about the leaf spring fixing position P2 is different depending on whether the leaf spring fixing position P2 is located lower or higher than the spring contact point P1.

Next, the movement of the spring contact point P1 by the rolling of an arc shape of the metal leaf spring 11, 12 will be described. A portion of the metal leaf spring 11, 12 contacting the resin plate material 10 has an arc shape. As illustrated in FIG. 3A, when a tip of the metal leaf spring 11 contacts the resin plate material 10, its tip has an arc shape. As illustrated in FIG. 3B, when a bent portion in the metal leaf spring 11 contacts the resin plate material 10, a portion of the bent portion contacting the resin plate material 10 has an arc shape. As illustrated in FIGS. 3A and 3B, when the height of the resin plate material 10 changes, the movement of the spring contact point P1 is caused by the rolling of the arc shape in addition to the movement of the spring contact point P1 caused by the rotation of the metal leaf springs 11, 12 as described above.

In the metal leaf spring 11 of the present disclosure in FIG. 3A, the moving direction of the spring contact point P1 by the rolling of the arc shape when the height of the resin plate material 10 changes from T1 to T2 is indicated by an arrow A3. The moving direction A3 of the spring contact point P1 by the rolling is the same direction as the moving direction A1 of the spring contact point P1 by the rotation of the metal leaf spring 11.

In the metal leaf spring 11 of the comparative example in FIG. 3B, the moving direction of the spring contact point P1 by the rolling of the arc shape when the height of the resin plate material 10 changes from T1 to T2 is indicated by an arrow A4. The moving direction A4 of the spring contact point P1 in the comparative example illustrated in FIG. 3B is the same direction as the moving direction A3 of the spring contact point P1 in the present disclosure illustrated in FIG. 3A. However, in the comparative example, the moving direction of the spring contact point P1 by the rotation of the metal leaf spring 11 is a direction away from the leaf spring fixing position P2. Therefore, the moving direction A3 of the spring contact point P1 by the rolling is different from the moving direction A2 of the spring contact point P1 by the rotation of the metal leaf spring 11.

In the metal leaf springs 11 and 12 of the present disclosure, a movement amount of the spring contact point P1 by the rotation is equal to a movement amount of the spring contact point P1 by the rolling of the arc shape in addition to the fact that the moving direction of the spring contact point P1 by the rotation of the metal leaf spring 11, 12 is the same as the moving direction of the spring contact point P1 by the rolling of the arc shape of the metal leaf spring 11, 12 as described above. This makes it possible to prevent the metal leaf spring 11, 12 from sliding on the resin plate material 10 at the spring contact point P1. That is, the moving direction and the movement amount of the spring contact point P1 by the rotation are the same as the moving direction and the movement amount of the spring contact point P1 by the rolling, so that a positional deviation can be restrained.

In accordance with the fluctuation of height of the resin plate material 10, a hysteresis has been conventionally generated between a curve in loading and a curve in unloading in a relationship between a stress and strain (displacement) of the metal leaf spring 11, 12. In contrast, in the metal leaf spring 11, 12 of the present disclosure, this hysteresis can be reduced to be, for example, halved. For example, in a case where a load (N) is changed from 0 N to 150 N and then is returned to 0 N, it is assumed that the displacement (mm) changes from 0 mm to about 1.2 mm to 1.6 mm. In this case, in the metal leaf spring 11, 12 of the present disclosure, the hysteresis can be reduced by about 48% as compared to the metal leaf spring 11, 12 of the comparative example.

As the material of the metal leaf spring 11, 12, a high strength material such as SUS301 CSP-H (Cold rolled Stainless steel Plate-Hard) (austenitic stainless steel, hard cold rolled stainless steel sheet) can be used. In the metal leaf spring 11, 12, when the thickness is too thick, the flexibility is decreased, compromising the function as the spring. On the other hand, when the thickness is too thin, it becomes difficult to apply a target load. Therefore, it is necessary to set the thickness to an appropriate thickness in consideration of a balance between the flexibility and the ability to apply a load.

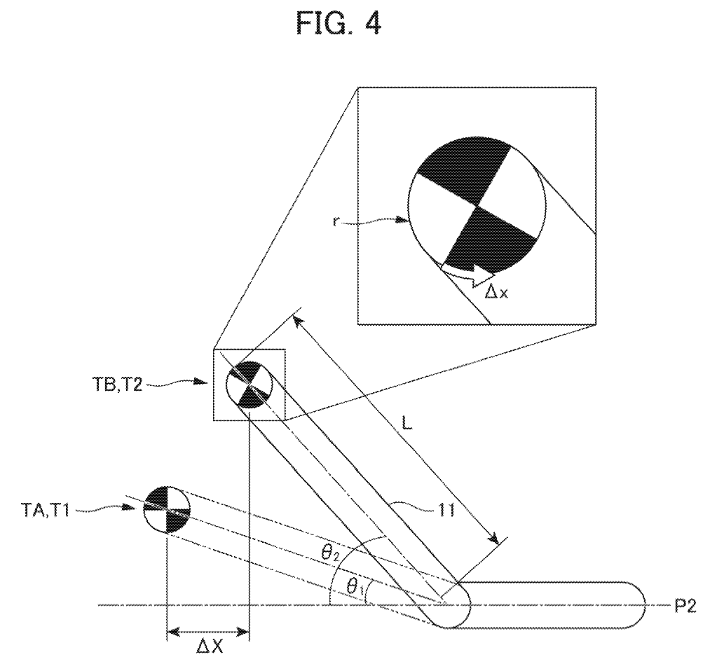

A method of calculating a movement amount of a spring contact point will be described with reference to FIG. 4. FIG. 4 illustrates the metal leaf spring 11 at an initial position (no loading) TA and the metal leaf spring 11 during load input (loading) TB. The initial position TA can be replaced with the height T1 of the resin plate material 10 described above. During load input (loading) TB can be replaced with the height T2 of the resin plate material 10 described above. The meanings of the length and the like shown in FIG. 4 are provided below. L: Length of metal leaf spring [mm]

r: Radius of arc shape of tip of metal leaf spring [mm]

θ₁: Angle of metal leaf spring at initial position TA

θ₂: Angle of metal leaf spring during load input TB

ΔX: Movement amount of contact point by rotation of metal leaf spring [mm]

Δx: Movement amount of contact point by rolling of arc of tip of metal leaf spring [mm]

In the present disclosure, the movement amount is set to satisfy ΔX = Δx. In other words, r, L, θ₁and θ₂are set to satisfy L × cosθ₁- L× cosθ₂ = r × (θ₂ - θ₁)

θ₂ can be adjusted by setting the thickness. This enables the movement amount of the spring contact point P1 by the rotation of the metal leaf spring 11, 12 to be equal to the movement amount of the spring contact point P1 by the rolling of the arc shape of the tip.

The cell assembly 1 for structural observation of the present disclosure can be modified in various ways other than the embodiment described above with reference to each figure such as FIGS. 1 and 2. For example, as the different pairs of metal leaf springs 11 and 12 having different spring constants, different pairs of metal leaf springs having the same planar shape projected on the main surface of the base member 5 and different thicknesses and being made of the same metal are prepared in the above-described embodiment, but in place of them, pairs of metal leaf springs having different planar shapes (widths) projected on the main surface of the base member 5 and the same thickness and being made of the same metal may be prepared. In either case, the metal leaf springs are preferably configured to be fastened with the leaf spring fastening screws 17 to be applied of the same dimension at the same positions.

### EXPLANATION OF REFERENCE NUMERALS

1 Cell assembly for structural observation

2 Rotation support member

3 Cell

4 Leaf spring

5 Base member

6 Base portion

7 Mounting portion

9 Electrode opposing part

10 Resin plate material

11 Metal leaf spring

12 Metal leaf spring

13 Base part

14 Base part

15 Support member

16 Leaf spring mounting plate

17 Leaf spring fastening screw

18 Mounting plate fastening screw

19 Negative electrode terminal

20 Positive electrode terminal

21 Negative electrode bus bar

22 Positive electrode bus bar

23 Container

23a First container portion

23b Second container portion

24 First container half

25 Second container half

26 Negative electrode opening

27 Positive electrode opening

28 Window

30 Base member fixing plate

31 Base member fixing plate fastening screw

40 X-ray irradiated portion

41 Side wall portion

A1 Direction in which spring contact point P1 moves by rotation in embodiment

A2 Direction in which spring contact point P1 moves by rotation in comparative example

A3 Direction in which spring contact point P1 moves by rolling in embodiment

A4 Direction in which spring contact point P1 moves by rolling in comparative example

L Length of metal leaf spring

P1 Spring contact point

P1A First spring contact point

P1B Second spring contact point

P2 Leaf spring fixing position

T1 Height of lower position of resin plate material

T2 Height of upper position of resin plate material

TA Initial position

TB During load input (loading)

U Upward direction

Va Virtual rotation axis

X X-ray irradiation position

a Region

g Gap

r Radius of arc shape of tip of metal leaf spring

θ₁ Angle of metal leaf spring at initial position TA

θ₂ Angle of metal leaf spring during load input TB

ΔX Movement amount of contact point by rotation of metal leaf spring

Δx Movement amount of contact point by rolling of arc of tip of metal leaf spring

What is claimed is:

1. A cell assembly for structural observation for observing an internal structure of a cell with an X-ray CT, the assembly comprising:
a pair of metal leaf springs that allow the cell, which is an observation target, to be sandwiched and restrained, from both surfaces of the cell; and
a sample holding part that is arranged between the metal leaf springs, wherein
fixing positions of the pair of metal leaf springs are closer to a terminal side of an electrode of the cell in a biasing direction than contact points between the metal leaf springs and the sample holding part, and
the sample holding part includes a thin X-ray irradiated portion.

2. The cell assembly for structural observation according to claim 1, wherein
the sample holding part includes thick side walls facing each other via the X-ray irradiated portion, and
tips of the metal leaf springs respectively contact the side wall portions.

3. The cell assembly for structural observation according to claim 2, wherein
the sample holding part has a concave shape in a cross-sectional view in a thickness direction,
a bottom of the concave shape is the X-ray irradiated portion, and
portions corresponding to side walls of the concave shape are the side wall portions.

4. The cell assembly for structural observation according to claim 2, wherein
the tips of the metal leaf springs each have an arc shape, and
a radius of the arc shape is set so that a movement of the contact points with the sample holding part by rotation of the metal leaf springs about the fixing positions of the metal leaf springs and a movement of the contact points with the sample holding part by rolling of the arc shape are performed in the same direction and by the same distance.
